(19) United States
(12) Patent Application Publication
(10) Pub. No.: US 2018/0093424 A1
(43) Pub. Date: Apr. 5, 2018

(54) DEVICE FOR WELDING PLASTIC

(71) Applicant: Timothy C. Lewis, Mendon, MA (US)

(72) Inventor: Timothy C. Lewis, Mendon, MA (US)

(21) Appl. No.: 15/722,441

(22) Filed: Oct. 2, 2017

Related U.S. Application Data
(60) Provisional application No. 62/402,387, filed on Sep. 30, 2016.

(51) Int. Cl. B29C 65/00; B29C 65/10

(52) U.S. Cl. CPC B29C 66/865; B23K 2203/42; B29C 65/10

(57) ABSTRACT

A device for welding plastic materials includes a handheld, wand-type applicator that dispenses a focused stream of oxygen-free air for optimum fusion. The applicator comprises a heating coil that warms the dispensed air to a sufficient temperature to sufficiently meld the plastic materials. A weld air delivery system delivers the supply of oxygen-free air to the weld applicator. A separate coolant air delivery system includes a tank that collects a reserve supply of ambient air that is used to cool the heating coil when applicator is not actively welding plastic materials. The inclusion of separate delivery systems ensures that ambient air is used to cool applicator, whereas oxygen-free air is preserved for use in welding applications. For safety purposes, a switch deactivates the heating coil when the pressure of the reserve air in the tank falls beneath a predefined threshold that is considered necessary to adequately cool the applicator.

### FIELD OF THE INVENTION

The present invention relates generally to welding devices and, more particularly, to devices designed principally for use in the welding of plastic materials.

### BACKGROUND OF THE INVENTION

Welding devices are well known in the art and are commonly used to join together certain items. Specifically, through the application of focused heat and/or pressure, materials of similar compositions can be fused together and, if necessary, reshaped to form a unitary item.

A plastic welder, or plastic welding tool, is one type of welding device that is designed primarily for use in the welding of plastic materials. Plastic welders typically include a handheld applicator, or nozzle, that delivers a focused stream of heated air. In use, a strip of filler material is often aligned between a multiple pieces of plastic of a similar composition. By applying a focused stream of heated air at the juncture, or joint, of the separate materials, the various plastic pieces heat and meld together to form a unitary structure.

Plastic welding tools of the type as described above have found particular usefulness in the automotive repair industry. For example, plastic welders are commonly used to meld cracked, torn or other similarly damaged automotive bumpers and panels. After the welding device is used to patch the damaged section, the joint is preferably buffed and painted to restore the component to its original appearance.

Although widely used across multiple industries, conventional plastic welders of the type as described above have been identified by the present inventor as suffering from a number of notable shortcomings.

As a first shortcoming, the present inventor has recognized that conventional plastic welders often yield a poor quality weld. Most notably, conventional plastic welding tools typically deliver a focused stream of heated ambient air to the intended weld site. However, the present inventor has recognized that the presence of oxygen in the supply of heated air compromises the quality and ultimately the strength of the weld. Most notably, it has been found that the oxygen creates a barrier that precludes full fusion of the separate pieces of plastic material.

As a second shortcoming, the present inventor has recognized that conventional plastic welders experience certain durability issues. In particular, it has been found that the nozzle that delivers the focused stream of heated air often overheats due to a lack of sufficient cooling means. As a result, the handheld applicator is rendered susceptible to damage or, even on occasion, melting after prolonged use.

As a third shortcoming, the present inventor has recognized that conventional plastic welders present certain safety hazards. Namely, traditional plastic welders are not typically equipped with means to monitor and regulate the temperature of certain components (e.g., the nozzle) over time. As a result, if inadequately monitored by the user, the device could pose a significant fire hazard.

### SUMMARY OF THE INVENTION

It is an object of the invention to provide a new and improved device for welding plastic.

It is another object of the present invention to provide a welding device as described above that designed to produce a strong and reliable weld.

It is yet another object of the present invention to provide a welding device as described above that is durable and safe to use.

It is still another object of the present invention to provide a welding device as described above that has a limited number of parts, is inexpensive to manufacture, and is easy to use.

Accordingly, as a feature of the present invention, there is provided a welding device comprising (a) a weld applicator adapted to receive a supply of air and selectively emit a focused stream of warm air, the supply of air received by the weld applicator having a pressure, (b) a coolant air delivery system for selectively delivering a supply of ambient air to the weld applicator for cooling purposes, and (c) a weld air delivery system for selectively delivering a supply of oxygen-free air to the weld applicator for welding purposes.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIGS. 1(a)-(c) are front perspective, rear perspective and right side perspective views, respectively, of a welding device constructed according to the teachings of the present invention;

FIG. 2 is a rear perspective view of the welding device shown in FIG. 1, the welding device being shown with the access panel disposed in its open position to display a select arrangement of internally-located components;

FIG. 3 is an enlarged front perspective view of the control panel shown in FIG. 1(a);

FIG. 4 is a simplified schematic representation of the welding unit for the device shown in FIG. 1(a), the interconnection of components being useful in understanding the basic pneumatic configuration for the welding unit; and

FIG. 5 is an enlarged right side perspective view of the device shown in FIG. 1(c), the device being shown with the air nozzle removed from its corresponding holder.

### DETAILED DESCRIPTION OF THE INVENTION

### Welding Device 11

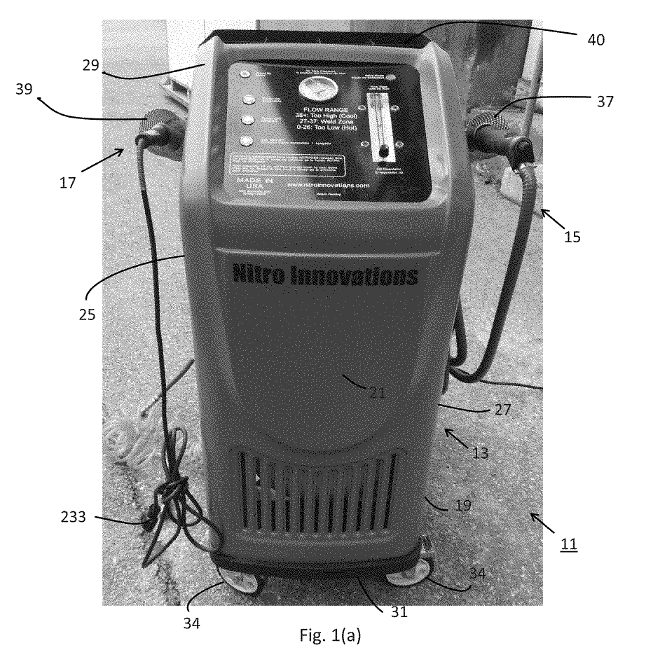

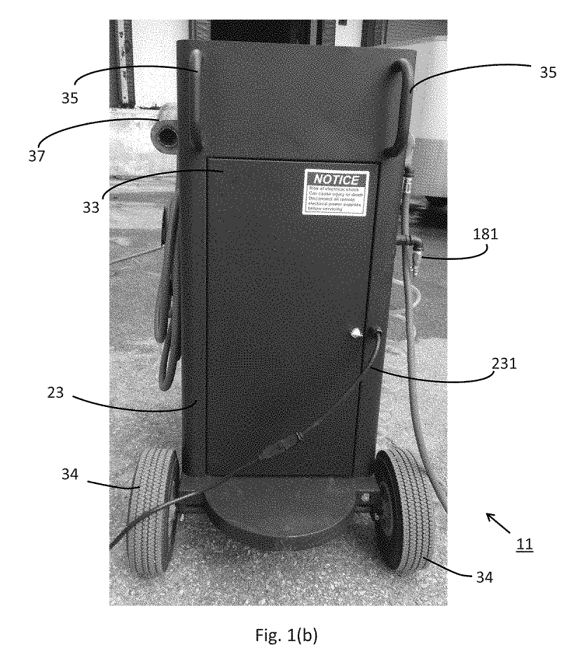

Referring now to FIGS. 1(a)-(c), there are shown front perspective, rear perspective, and right side perspective views, respectively, of a welding device constructed according to the teachings of the present invention, the welding device being identified generally by reference numeral 11. As will be described in detail below, welding device 11 is specifically designed to yield a high-quality and durable weld in a safe and reliable fashion.

Welding device 11 is designed primarily for use in the welding together of plastic materials of similar compositions. Most notably, device 11 is particularly well-suited for use in repairing cracked, torn or otherwise damaged automotive bumpers, which are traditionally constructed of polypropylene or other similar thermoplastic material. However, it should be noted that device 11 is not limited for use in the welding of specific materials in any particular application. Rather, it is to be understood that device 11 could be used to weld different types of materials and/or in alternative ranges of applications (e.g. the repair of prosthetics or fiber optic cables) without departing from the spirit of the present invention.

Welding device 11 comprises a movable cart 13 that houses both (i) a pneumatic-based welding unit 15 with improved plastic welding capabilities and (ii) a conventional soldering unit, or iron, 17 in electrical connection with welding unit 15. As will be explained in detail below, welding unit 15 is specifically designed to yield a high-quality weld of plastic materials in a safe, durable and reliable fashion. As a result, the particular construction and functionality of welding unit 15 serve as the primary novel aspects of the present invention. By comparison, although soldering unit 17 does not yield as strong and reliable a weld as welding unit 15, the smaller-sized soldering unit 17 is provided nonetheless for applications in which a quick, limited-size, limited-strength weld is considered adequate (e.g. in an area that is difficult to access).

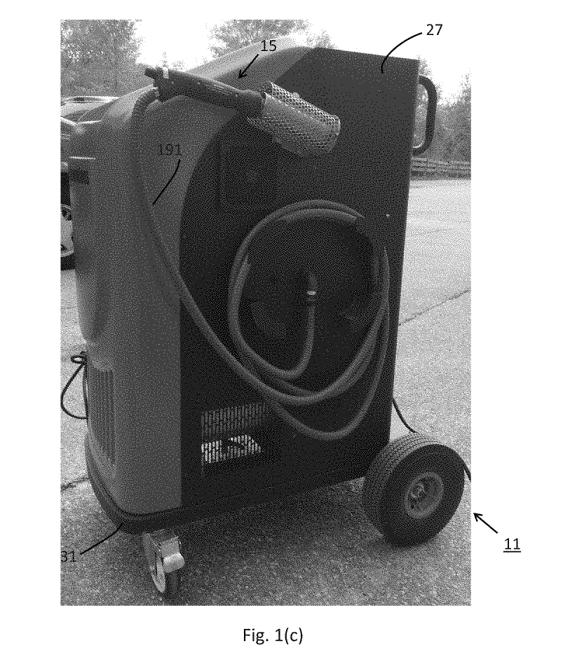

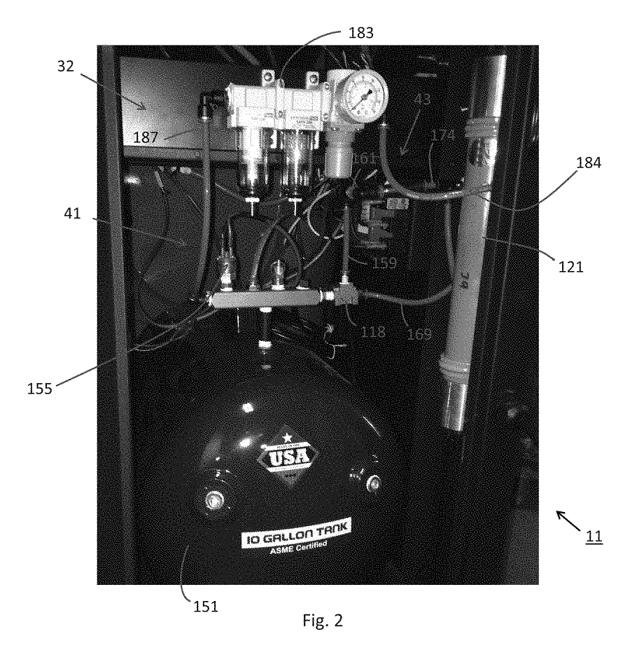

Cart 13 comprises a multi-panel, protective housing 19 which includes a substantially enclosed front panel 21, a selectively enclosable rear panel 23, a pair of substantially enclosed side panels 25 and 27, a substantially enclosed top panel 29 and an enclosed bottom panel 31 that together define an enlarged interior cavity 32, shown in FIG. 2, which is appropriately dimensioned to receive the majority of the components of welding unit 15. In this manner, cart 13 provides welding device 11 with an integrated and highly compact construction.

As seen most clearly in FIG. 1(b), an access panel, or door, 33 is pivotally coupled to rear panel 23. With door 33 disposed in its open position, any required assembly and/or maintenance of welding unit 15 can be easily achieved through open rear panel 23.

A plurality of wheels 34 is preferably mounted onto bottom panel 31 of housing 19. Additionally, a pair of U-shaped handles 35 is fixedly secured to rear panel 23 of housing 19. Accordingly, using handles 35, cart 13 can be easily transported within a facility for use in different environments.

Cart 13 is additionally provided with a weld applicator holder 37 on the exterior surface of right side panel 27 as well as a soldering tool holder 39 on the exterior surface of left side panel 25. As will be explained further below, holders 37 and 39 releasably retain the handheld applicators for welding unit 15 and soldering unit 17, respectively, in an easily accessible location for use. Furthermore, each of holders 37 is preferably constructed of a thermally conductive material, such as metal, and includes means to facilitate the dissipation of heat, such as air holes or fins.

Top panel 29 is shaped to define a plurality of open rectangular cavities 40 along its rearward edge. As can be appreciated, cavities 40 are appropriately dimensioned to retain instruments and supplies that are commonly utilized in welding applications.

### Welding Unit 15

As will be explained in detail below, welding unit 15 is specifically constructed with a series of novel features that together resolve certain shortcomings associated with conventional plastic welding tools. In particular, welding unit 15 is designed to, among other things, (i) provide effective cooling that minimizes the risk of tool overheating, and (ii) deliver an oxygen-free stream of heated air that, in turn, is used to produce an optimal weld of plastic materials.

Referring now to FIGS. 2-4, welding unit 15 generally comprises a multi-path air conduit system 41 for, inter alia, selectively delivering a supply of heated air to a weld site, a control circuit 43 for regulating the air flow path within conduit system 41, and a control panel 45 for monitoring and manually regulating operation of control circuit 43, as will be explained further below.

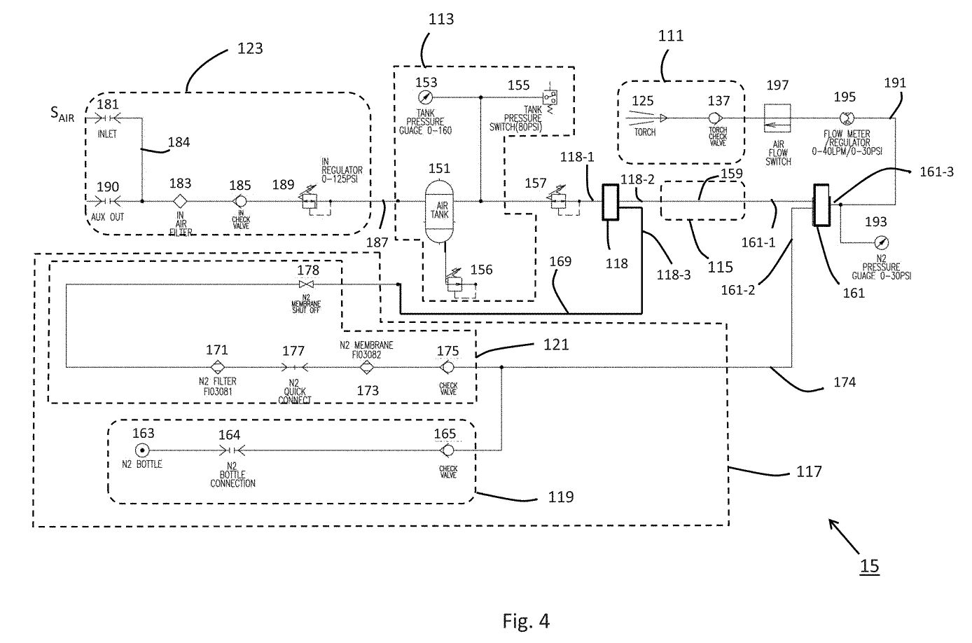

As seen most clearly in FIG. 4, welding unit 15 comprises a weld applicator 111 that is designed to selectively deliver a focused stream of oxygen-free, heated air to a desired weld site, an air storage unit 113 for collecting a supply of compressed ambient air from a designated source S_{AIR}, a coolant air delivery system 115 for selectively providing a stream of compressed ambient air from air storage unit 113 to applicator 111 for cooling purposes, a weld air delivery system 117 for selectively providing a stream of nitrogen gas (i.e. oxygen-free air) to applicator 111 for use in welding applications, and a control device 118 for regulating whether the delivery of air to applicator 111 is provided from coolant air delivery system 115 or weld air delivery system 117. As can be appreciated, the inclusion of separate delivery systems 115 and 117 ensures that untreated, ambient air is used to maintain weld applicator 111 at a suitable temperature (i.e. for safety purposes), whereas treated, oxygen-free air is preserved solely for use in welding applications, which is a significant feature of the present invention.

As represented herein, welding unit 15 is designed such that the supply of nitrogen gas delivered by system 117 is received either from (i) a designated nitrogen gas source 119, or (ii) a nitrogen separation unit 121 that separates nitrogen from a supply of compressed ambient air collected in storage unit 113. However, it is to be understood that welding unit 15 could be equipped with only a single means for providing nitrogen to weld air delivery system 117 (i.e. either air source 119 or separation unit 121) without departing from the spirit of the present invention.

Welding unit 15 additionally includes an input air treatment system 123 that is adapted to receive compressed air from the compressed air source S_{AIR}. In turn, system 123 is designed to clean and control the delivery of the cleaned compressed air to air storage unit 113.

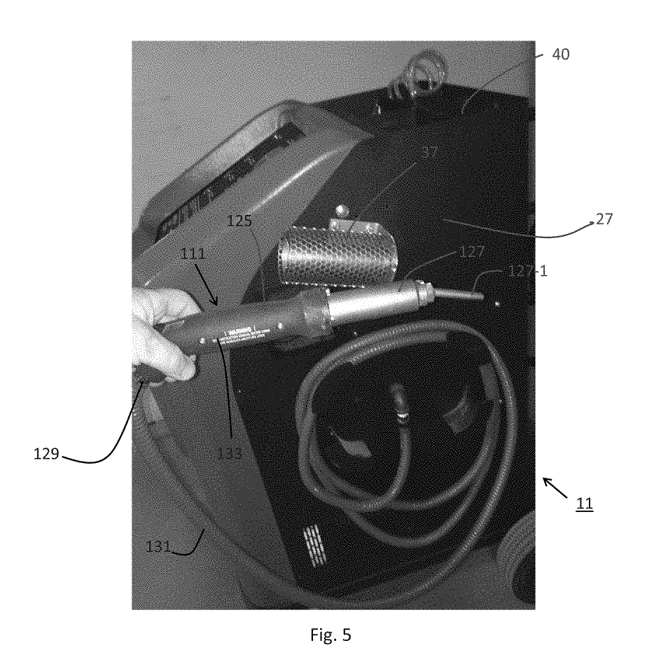

As seen in most clearly in FIG. 5, weld applicator 111 is constructed as a handheld nozzle, or wand, 125 that is designed to deliver a focused stream of heated air. Nozzle 125 comprises an elongated, tubular heating coil 127 which defines a longitudinally-extending internal conduit (not shown) therethrough, the heating coil 127 including a reduced diameter stem 127-1 at one end which defines the outlet through which the weld air is acutely delivered. A coupling mechanism 129 is provided on nozzle 125 at the inlet of the internal conduit to receive air from an elongated tube 131 in fluid communication with systems 115 and 117.

A non-conductive sleeve, or handle, 133 is wrapped around a length of heating coil 127 and provides a thermally-insulated means for a user to grasp and manipulate air nozzle 111. When not in use, heating coil 127 of nozzle 111 is preferably retained in mesh holder 37, thereby providing means for the safe dissipation of heat from coil 127 as well as for easy access of handle 133 in any future use.

Referring back to FIG. 4, weld applicator 111 additionally includes a nozzle check, or one-way, valve 137 for regulating airflow through nozzle 125 and limiting such airflow in only one direction (i.e. prevents backflow). Furthermore, as will be described in detail below, weld unit 15 is designed with means for monitoring and manually adjusting the air pressure delivered to nozzle 125 from systems 115 and 117.

In use, with heating coil 127 activated, air flowing through the internal conduit is heated to a designated melting temperature that is required to adequately weld plastic materials. As will be explained further below, the activation state of heating coil 127 is regulated by control circuit 43 to ensure that weld applicator 111 does not overheat and thereby create a potentially hazardous and/or damaging condition.

As seen most clearly in FIGS. 2 and 4, air storage unit 113 comprises a 10 gallon air tank 151 that is preferably retained within interior cavity 32 of cart 13. Air tank 151 is provided to receive and store a supply of compressed ambient air from designated air source S_{AIR}. As will be explained further in detail below, welding unit 15 is designed such that air tank 151 maintains an adequate reserve of compressed ambient air in order to prevent overheating of handheld nozzle 125, which is a principal object of the present invention.

Air storage unit 113 additionally includes a tank pressure gauge 153 for measuring the amount of air pressure within air tank 151 (e.g. in the range of 0-160 psi), a tank pressure switch 155 in communication with gauge 153, and a tank relief valve 156. As will be explained further below, when the measured air pressure within air tank 151 falls beneath a predefined threshold (e.g. 50 psi), switch 155 generates an appropriate alert signal. In response, control circuit 43 prevents activation of heating coil 127 since there is an inadequate supply of reserve air that is needed to minimize the risk of nozzle 125 overheating. Similarly, when the measured air pressure within air tank 151 exceeds a predefined threshold (e.g. 160 psi), relief valve 156 releases air from tank 151 to ensure tank pressure remains at a safe level.

As referenced briefly above, welding unit 15 includes a control device 118 for regulating the delivery of air to weld applicator 111 from either of two separate air delivery systems 115 and 117. As represented herein, control device 118 is in the form of a flow control switch valve which has an input 118-1 adapted to receive a supply of compressed ambient air from tank 151, the airflow delivered from tank 151 being controlled by an airflow regulator 157.

A first output 118-2 of control device 118 is designed for connection to coolant air delivery system 115 and a second output 118-3 of control device 118 is designed for connection to nitrogen separation unit 121 of weld air delivery system 117. In this manner, control device 118 regulates whether compressed air released from air tank 151 is ultimately delivered to weld applicator 111 via coolant air delivery system 115 or weld air delivery system 117.

Coolant air delivery system 115 is designed to selectively deliver a stream of compressed ambient air from air tank 151 to weld applicator 111 in order to prevent overheating of air nozzle 125. More specifically, to cool heating coil 127 when applicator 111 is not being used in welding applications, a continuous flow of compressed air is delivered by system 115 to air nozzle 125. As can be appreciated, the use of ambient air to cool weld applicator 111 when not in use is preferred in order to preserve nitrogen gas for welding purposes.

Coolant air delivery system 115 is represented herein simply as a length of flexible tubing 159 that connects control device 118 to a first input 161-1 of a T-type connector 161, the function of which will become apparent below. As such, coolant air delivery system 115 is designed to deliver compressed air from tank 151 directly to weld applicator 111 (i.e. without applying any treatment to the air).

By comparison, weld air delivery system 117 selectively delivers a stream of nitrogen gas (i.e. oxygen-free air) to air nozzle 125 for use in welding applications. As can be appreciated, the present inventor has recognized that the use of nitrogen gas in plastic welding applications provides a significantly stronger and more reliable weld than conventional devices that utilize heated ambient air to weld plastic materials. Accordingly, by including separate air delivery systems 115 and 117, ambient air can be utilized for cooling purposes, whereas nitrogen gas can be preserved for use solely in welding applications. By limiting the use of nitrogen gas to welding applications, the lifespan of certain sensitive components and/or costly supplies utilized to generate the nitrogen gas source can be extended.

As referenced previously, weld air delivery system 117 produces a supply of nitrogen gas from either of two sources. As a first source, system 117 comprises a designated nitrogen gas source 119 that includes a replaceable nitrogen bottle 163. As a second source, system 117 comprises a nitrogen separation unit 121 that separates nitrogen from compressed air stored in air tank 151. The outputs of both nitrogen gas source 119 and nitrogen separation unit 121 are joined together and connected to a second input 161-2 of T-connector 161.

Nitrogen bottle, or cylinder, 163 represents any packaged supply of nitrogen that is preferably dimensioned for storage within interior cavity 32 of cart 13. Bottle 163 is coupled to the remainder of air source 119 by a suitable connector 164. In this manner, bottle 163 can be easily removed, replaced and/or refilled, as deemed necessary. A one-way check valve 165 is preferably provided in the delivery path from bottle 163 to connector 161 to regulate the delivery of nitrogen gas from air source 119 as well as prevent any backflow of nitrogen gas from bottle 163.

Nitrogen separation unit 121 is connected to output 118-3 of control device 118 by a length of tubing 169 that delivers compressed ambient air from air tank 151 to a nitrogen filter 171, which in turn removes any contaminants in the ambient air supply. The contaminant-free air is then delivered to a nitrogen membrane 173 which separates nitrogen from the filtered air supply. As a result, a nitrogen gas source is created from the ambient air supply that is in turn delivered to second input 161-2 of T-connector 161 through a flexible hose 174.

A one-way check valve 175 is preferably provided in the delivery path from nitrogen membrane 173 to T-connector 161 to regulate the delivery of nitrogen from air source 121 as well as prevent any backflow. Additionally, the delivery path from air tank 151 to nitrogen membrane 173 includes a quick-connect coupling mechanism 177, which facilitates the installation, removal and/or replacement of membrane 173 from nitrogen separation unit 121, and an optional membrane shutoff valve 178 for regulating airflow into nitrogen separation unit 121.

Although not shown herein, an auxiliary connector is preferably provided at some point along the air delivery path of nitrogen into T-connector 161. Such a connector would enable an air accessory (e.g. a blow gun or tire inflation kit) to be coupled to weld air delivery system 117 via one or more connective hoses. As a result, weld device 11 could be used to dispense nitrogen gas in a wide variety of potential applications (e.g. to fill certain types of automotive tires).

Input air treatment system 123 is designed to clean and regulate the delivery of ambient air from a compressed air source S_{AIR} to air tank 151. Preferably, air source S_{AIR} represents any supply of compressed air (e.g. air compressed at 100 psi), such as a portable canister that can be retained within interior cavity 32 or a larger shop air system. To receive compressed air from a designated shop line, a compressed air coupler 181, shown in FIG. 1(b), is externally mounted on left side panel 25.

As seen most clearly in FIGS. 2 and 4, the compressed air provided by air source S_{AIR} is delivered to a compressed air filter 183 via tubing 184. Upon receipt of the compressed air, filter 183 removes water, oils and other similar contaminants therefrom.

In FIG. 4, compressed air filter 183 is represented as having a dual-filtration construction, with a 5 micron filter initially removing larger contaminants and a 0.01 micron filter subsequently removing smaller contaminants. However, it is to be understood that compressed air filter 183 could rely upon any filtration construction without departing from the spirit of the present invention.

Air fill, or one-way, check valve 185 is coupled to the output of filter 183 to regulate airflow into air tank 151 as well as to prevent backflow. A length of tubing 187 connected to the output of check valve 185 delivers the filtered compressed air to air tank 151. Preferably, an airflow regulator 189 ensures that the compressed air is continuously delivered to air tank 151 at an ideal pressure level (e.g. 100 psi).

An auxiliary connector 190 in fluid communication with inlet 181 preferably extends outside of cart 13. Connector 190 is designed to be coupled to any conventional pneumatic accessory (e.g. a blow gun). In this capacity, connector 190 renders device 11 capable of delivering compressed air to a desired object (e.g. an automotive tire).

As referenced above, control device 118 regulates whether the air delivered to weld applicator 111 is either (i) compressed ambient air that is used strictly for cooling purposes or (ii) oxygen-free air that is utilized solely for welding applications.

As shown in FIG. 4, output 161-3 of T-connector 161 is delivered to weld applicator 111 via one or more lengths of interconnected tubing 191 that extend from interior cavity 32 to outside cart 13. As will be explained in detail below, welding unit 15 is provided with user-controllable means for regulating the pressure of the airflow delivered to nozzle 125 via tubing 191.

Specifically, as can be seen, weld unit 15 comprises an air pressure gauge 193 for measuring the air flow pressure being delivered to air nozzle 125 from connector 161 and an airflow regulator 195 for manually controlling the airflow pressure delivered to weld applicator 111 in a precise fashion and within a defined range (e.g. 0-30 psi). This ability to adjust the airflow pressure delivered to applicator 111 enables weld unit 15 to accommodate distinct needs that are required in certain situations. For instance, lower pressure airflow might be desired, in certain circumstances, to preserve a relatively limited supply of oxygen-free air. In other situations, higher pressure airflow might be desired in order to extract a limited amount of nitrogen gas that remains in a removable nitrogen canister 163.

Lastly, an air flow safety switch 197 is disposed in fluid communication with airflow regulator 195 to ensure that the airflow delivered to applicator 111 remains within a preferred pressure range (e.g. 20-30 psi). For instance, if the airflow level set using regulator 195 falls beneath the minimum threshold determined to prevent applicator 111 from overheating, airflow switch 197 is triggered. In response thereto, control circuit 43 deactivates heating coil 127 to prevent the hazardous condition. Similarly, if the airflow level set using regulator 195 exceeds the maximum threshold determined to yield an acceptable weld, airflow switch 197 is triggered which, in turn, causes control circuit 43 to deactivate heating coil 127.

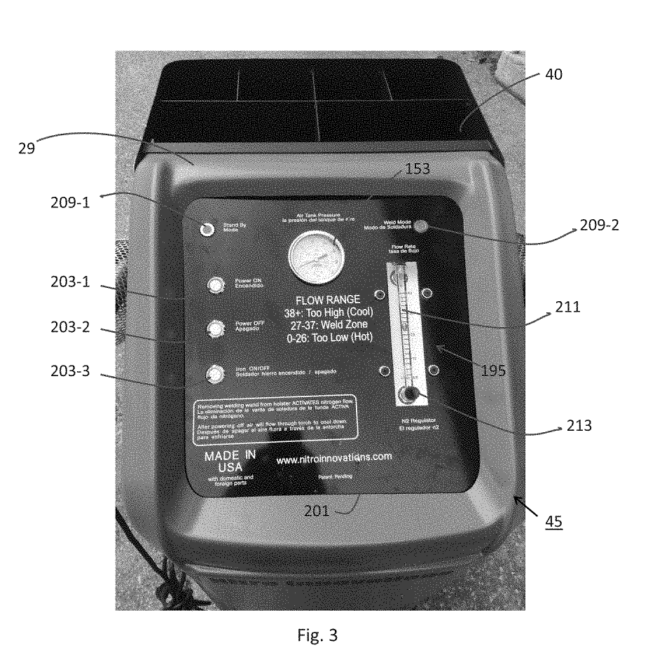

Referring now to FIG. 3, control panel 45 provides the user with highly intuitive means for monitoring and controlling the basic operations of welding unit 15. As can be seen, control panel 45 is mounted primarily within an open window 201 in top panel 29 and is preferably angled for suitable viewing by an operator.

Control panel 45 includes a series of manually-depressible power buttons 203-1, 203-2 and 203-3, each button 203 being in electrical connection with control circuit 43. As will be explained in detail below, each button 203 serves to regulate certain basic power operations associated with device 11.

Control panel 45 additionally includes a status indicator 209-1 as well as a weld indicator 209-2, each indicator 209 being in electrical connection with control circuit 43. As will be explained further below, status indicator 209-1 is in the form of a light emitting diode (LED) that is designed to illuminate in a highly intuitive fashion to notify the user of the operational status of weld unit 15. Similarly, weld indicator 209-2 is in the form of an LED that is designed to illuminate in a highly intuitive fashion to notify the user when applicator 115 is in its weld mode (i.e. emitting oxygen-free air for welding applications).

Control panel 45 further includes tank pressure gauge, or meter, 153. As previously referenced, pressure gauge 153 displays the real-time air pressure in reserve tank 151.

Lastly, control panel 45 includes airflow regulator 195 which, as previously mentioned, can be used to regulate the pressure level of air delivered to applicator 111 from systems 115 and 117. As can be seen, regulator 195 includes a calibrated, flowmeter, or scale, 211 that displays the user-specified air pressure setting to be applied to applicator 111 and a rotatable knob 213 for manually adjusting the air pressure setting displayed on flowmeter 211.

### Operation of Welding Device 11

Referring primarily to FIG. 4, welding device 11 can be used in the following manner to weld together plastic materials, such as cracked automotive bumpers. As part of the initial setup process, an externally accessible power cord 231 in electrical communication with control circuit 43 is connected to an electrical power source, as shown in FIG. 1(b), to deliver the requisite electrical power to device 11. Additionally, an electrical plug 233 for soldering iron 17, as shown in FIG. 1(a), is plugged into a designated outlet (not shown) in communication with control circuit 43. In this manner, operation of soldering unit 17 can be regulated through control panel 45.

Lastly, compressed air source S_{AIR} is coupled to inlet 181 of air input system 123. Preferably, compressed air source S_{AIR} is provided either from an external air compressor line (for widespread use within a facility) or a reduced-size air compressor that may be stored inside cart 13 to render device 11 more portable in the field.

While in its initial unpowered state, air check valve 185 remains closed, thereby precluding the delivery of any air from air source S_{AIR} into air storage unit 113. At the same time, air check valve 137 remains open, thereby enabling any compressed air present in air tank 151 to flow out, or bleed down, through air nozzle 125.

Activation of device 11 is achieved through control panel 45. Specifically, to engage in a plastic welding activity, power button 203-1 is depressed. Activation of power button 203-1 causes control circuit 43 to open air fill valve 185 and close nozzle check valve 137, thereby resulting in the initial delivery and collection of compressed air from designated air source S_{AIR} to air tank 151. As referenced previously, compressed ambient air delivered from air source S_{AIR} is preferably treated by coalescing filter 183 and regulated in airflow pressure by regulator 189.

During this initialization state, device 11 is not available for soldering purposes. Rather, the delivered air simply collects in a pressurized fashion within reserve tank 151. To intuitively notify the user of the initialization, or pressurization, status of device 11, status indicator 209-1 on control panel 45 repeatedly flashes to denote that device 11 has been powered but welding capabilities are not yet available.

As a feature of the present invention, control circuit 43 precludes activation of heating coil 127 in wand 125 until the air pressure level in air tank 151 reaches a predefined threshold (50 psi). The inclusion of a tank pressurization period ensures that an adequate reserve of compressed air remains available for use in sufficiently cooling air nozzle 125 upon completion of the welding process, as will be explained further below.

Once the requisite air pressure threshold is measured by tank pressure gauge 153, control circuit 43 advances device 11 to a ready, or standby, state. Specifically, once in the standby state, pressure switch 155, which is in communication with gauge 153, sends an appropriate signal that results in the activation of heating coil 127 in wand 125. At the same time, control circuit 43 opens nozzle check valve 137 which results in the delivery of a continuous flow of compressed air from tank 151 via coolant air delivery system 115. As can be appreciated, this release of coolant air from tank 151 prevents overheating of nozzle 125 when heating coil 127 is active but device 11 is not being used in welding applications, which is a novel feature of the present invention. To notify the user that device 11 has reached its standby state, control circuit 43 switches status indicator 209-1 to a solid illumination condition to indicate readiness for welding.

With wand 125 retained in holder 37 and detected as such by an externally mounted light sensor in communication with control circuit 43, device 11 remains in its standby state. To move device 11 into a welding state, the user simply removes wand 125 from its designated holder 37. With wand 125 detected as being withdrawn from holder 37, the light sensor sends an appropriate signal which causes control circuit 43 to switch flow control switch valve 118 such that the air delivered to weld applicator 111 is provided from weld air delivery system 117 instead of coolant air delivery system 115. To intuitively notify the user that device 11 is now in its operational welding state, control circuit 43 turns off status indicator 209-1 and illuminates weld indicator 209-2.

With device 11 in its operational welding state, nitrogen gas is delivered to weld applicator 111. In turn, heating coil 127 warms the flow of nitrogen gas and emits a focused stream of heated, oxygen-free air out through applicator stem 127-1. A strip of filler material is then disposed between the plastic materials in need of welding. By applying a focused stream of heated nitrogen gas at the juncture, or joint, of the separate materials, the various plastic pieces heat and meld together to form a unitary structure. As previously mentioned, the use of oxygen-free air creates a stronger, cleaner, and more durable weld, which is highly desirable.

As referenced previously, the user can manually regulate the airflow pressure delivered to nozzle 125 by adjusting regulator 195. This enables the airflow pressure delivered to weld applicator 111 to be varied to suit the particular needs of the user (e.g. to preserve a limited nitrogen supply).

Upon completion of the intended welding application, the user returns wand 125 to holder 37 until further welding is required. When the weld applicator 111 is returned to holder 37, the light sensor sends an appropriate signal to control circuit 43 which, in turn, returns device 11 to its standby state. In other words, control circuit 43 (i) maintains heating coil 127 in its activated state, (ii) switches flow control switch valve 118 back to its original state (with check valve 137 remaining open) so that airflow delivered to applicator 111 is provided from coolant air delivery system 115, and (iii) turns off weld indicator 209-1 and solidly illuminates status indicator 209-1 to indicate readiness for future welding.

It is important to note that, with device 11 in its standby state, compressed ambient air is continuously delivered to weld applicator 111 from air tank 151 to prevent any overheating of air nozzle 125. This functionality incorporated into device 11 is highly desirable, as it preserves use of weld air delivery system 117 and, in particular, nitrogen membrane 173 for welding applications. As a result, the overall lifespan of weld device 11 is significantly extended.

When any further welding is required, the user simply withdraws wand 125 from its designated holder 37, which automatically switches device 11 to its welding state. Upon completion, wand 125 is returned to holder 37, which switches device 11 back to its standby state. This process can be repeated, as needed, to enable a considerable amount of welding to be undertaken over an extended period of time.

Once no further welding is required, the user can power off welding device 11 by depressing power off button 203-3 on control panel 45. In response, control circuit 43 returns device 11 to its initial unpowered state, with air fill valve 185 closed and nozzle check valve 137 remaining open such that reserve compressed air stored in tank 151 bleeds out and cools down deactivated heating coil 127.

As referenced above, the reserve air collected in tank 151 is required to cool heating coil 127 upon completion of the welding process. Otherwise, with weld device 11 powered off and/or disconnected from designated air source S_{AIR}, the lack of an adequate supply of coolant air in reserve will cause heating coil 127, which continues to dissipate heat upon deactivation, to potentially burnout and/or overheat wand 125. As can be appreciated, heat dissipated from coil 127 not only creates a hazardous condition but also may permanently damage (e.g. melt) wand 125.

If the user forgets to power off device 11 and no welding activity occurs for a designated period of time (e.g. 60 minutes), a time sensor in control circuit 43 sends a signal which results in an automatic powering down device 11. Every time wand 125 is withdrawn from holder 37, the time sensor is reset. Upon the return of wand 125 to holder 37, the safety timer commences a new timing period.

As previously mentioned, device 11 is provided with a soldering iron 17 for certain uses in which a quick, limited-size, limited-strength weld is considered adequate. To activate soldering iron 17, the user simply depresses soldering button 203-3 on control panel 45. Thereafter, the user can engage in a soldering application by withdrawing iron 17 from holder 39. To deactivate soldering iron 17, the user again depresses button 203-3 and preferably stores iron 17 back in holder 39 for ease of future access. If the user forgets to power off soldering iron 17, a time sensor in control circuit 43 is preferably provided to automatically power down iron 17 after a designated period of time (e.g. 60 minutes).

The embodiment shown above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A welding device, comprising:
(a) a weld applicator adapted to receive a supply of air and selectively emit a focused stream of warm air, the supply of air received by the weld applicator having a pressure;
(b) a coolant air delivery system for selectively delivering a supply of ambient air to the weld applicator for cooling purposes; and
(c) a weld air delivery system for selectively delivering a supply of oxygen-free air to the weld applicator for welding purposes.

2. The welding device as claimed in claim 1 further comprising a control device for regulating the delivery of air to the weld applicator from the coolant air delivery system and the weld air delivery system.

3. The welding device as claimed in claim 2 wherein the control device is a flow control switch valve that receives the supply of ambient air from the coolant air delivery system and the supply of oxygen-free air from the weld air delivery system, the control device selectively delivering each of the supply of ambient air and the supply of oxygen-free air to the weld applicator.

4. The welding device as claimed in claim 3 further comprising an air storage unit, the air storage unit including an air tank for collecting a reserve supply of ambient air, the reserve supply having a pressure.

5. The welding device as claimed in claim 4 wherein the air storage unit comprises a tank pressure gauge for measuring the pressure of the reserve supply of ambient air.

6. The welding device as claimed in claim 5 wherein the air storage unit comprises a tank pressure switch in communication with the tank pressure gauge, the tank pressure switch being in electrical communication with the heating coil in the weld applicator.

7. The welding device as claimed in claim 6 wherein the weld applicator includes a heating coil that selectively warms the supply of air received by the weld applicator.

8. The welding device as claimed in claim 7 wherein the weld applicator additionally includes a handle disposed around at least a portion of the heating coil.

9. The welding device as claimed in claim 7 wherein the tank pressure switch deactivates the heating coil when the pressure of the reserve supply of ambient air in the air tank falls beneath a defined threshold.

10. The welding device as claimed in claim 9 wherein the defined threshold is 50 psi.

11. The welding device as claimed in claim 3 further comprising an airflow regulator for controlling the pressure of the supply of air delivered to the weld applicator.

12. The welding device as claimed in claim 3 wherein the weld air delivery system comprises a designated nitrogen gas source for producing the supply of oxygen-free air that is delivered to the weld applicator for welding purposes.

13. The welding device as claimed in claim 12 wherein the designated nitrogen gas source comprises a removable nitrogen tank that retains a packaged supply of oxygen-free air.

14. The welding device as claimed in claim 3 further comprising an input air treatment system adapted to receive ambient air from an air source.

15. The welding device as claimed in claim 14 wherein the weld air delivery system comprises a nitrogen separation unit for producing the supply of oxygen-free air that is delivered to the weld applicator for welding purposes.

16. The welding device as claimed in claim 15 wherein the nitrogen separation unit separates the supply of oxygen-free air from ambient air received by the input air treatment system.

17. The welding device as claimed in claim 16 wherein the nitrogen separation unit includes a nitrogen membrane that separates the supply of oxygen-free air from ambient air received by the input air treatment system.

18. The welding device as claimed in claim 3 wherein the welding device is integrated into a movable cart.

19. The welding device as claimed in claim 18 wherein the movable cart comprises,
(a) a protective housing shaped to define an enclosable interior cavity dimensioned to receive select components of the welding device;
(b) a plurality of wheels mounted on the housing; and
(c) a pair of handles mounted on the housing.

20. The welding device as claimed in claim 3 further comprising a soldering tool.
